(19) United States
(12) Patent Application Publication
(10) Pub. No.: US 2014/0177157 A1
(43) Pub. Date: Jun. 26, 2014

(54) NOTEBOOK COMPUTER AND METHOD FOR AUTOMATICALLY OPENING COVER OF NOTEBOOK COMPUTER

(71) Applicants: HON HAI PRECISION INDUSTRY CO., LTD., New Taipei (TW); HONG FU JIN PRECISION INDUSTRY (Wuhan) CO., LTD., Wuhan (CN)

(72) Inventors: JIAN-HUNG HUNG, New Taipei (TW); MIN YANG, Wuhan (CN); XIN-SHU WANG, Wuhan (CN)

(73) Assignees: HON HAI PRECISION INDUSTRY CO., LTD., New Taipei (TW); HONG FU JIN PRECISION INDUSTRY (WUHAN) CO., LTD., Wuhan (CN)

(21) Appl. No.: 14/086,997

(22) Filed: Nov. 22, 2013

(30) Foreign Application Priority Data
Dec. 25, 2012 (CN) 2012105718673

(51) Int. Cl. G06F 1/16

(52) U.S. Cl. CPC G06F 1/1637
USPC 361/679.27

(57) ABSTRACT

In a method for automatically opening a cover of a notebook computer, the cover includes a display screen and a gravity sensor. The notebook computer further includes a base member, a signal receiver, and a driver device. The signal receiver receives a power-on signal from a remote controller, and the driver device rotates a rotating element of the notebook computer to open the cover upon receiving the power-on signal. The gravity sensor detects an angle of the display screen. The method determines whether the angle of the display screen is equal to a preset operation angle between the cover and the base member, and controls the driver device to fix the display screen at the operation angle.

### BACKGROUND

1. Technical Field

Embodiments of the present disclosure relate to display systems and methods, and particularly to a notebook computer and a method for automatically opening a cover of the notebook computer.

2. Description of Related Art

A notebook computer has a display screen mounted in a cover connected to a base member. The display screen is rotatable to different viewing angles. However, it is inconvenient for a user to manually adjust an angle of the display screen. Therefore, there is room for improvement within the prior art.

### BRIEF DESCRIPTION OF THE DRAWINGS

FIG. 1 is a block diagram of one embodiment of a notebook computer including a cover opening system.

FIG. 2 is one embodiment of an external structure of the notebook computer.

FIG. 3 is a flowchart of one embodiment of a method for automatically opening a cover of the notebook computer.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean “at least one.”

In the present disclosure, the word “module,” as used herein, refers to logic embodied in hardware or firmware, or to a collection of software instructions, written in a program language. In one embodiment, the program language may be Java, C, or assembly. One or more software instructions in the modules may be embedded in firmware, such as in an EPROM. The modules described herein may be implemented as either software and/or hardware modules and may be stored in any type of non-transitory computer-readable media or storage medium. Some non-limiting examples of a non-transitory computer-readable medium include CDs, DVDs, flash memory, and hard disk drives.

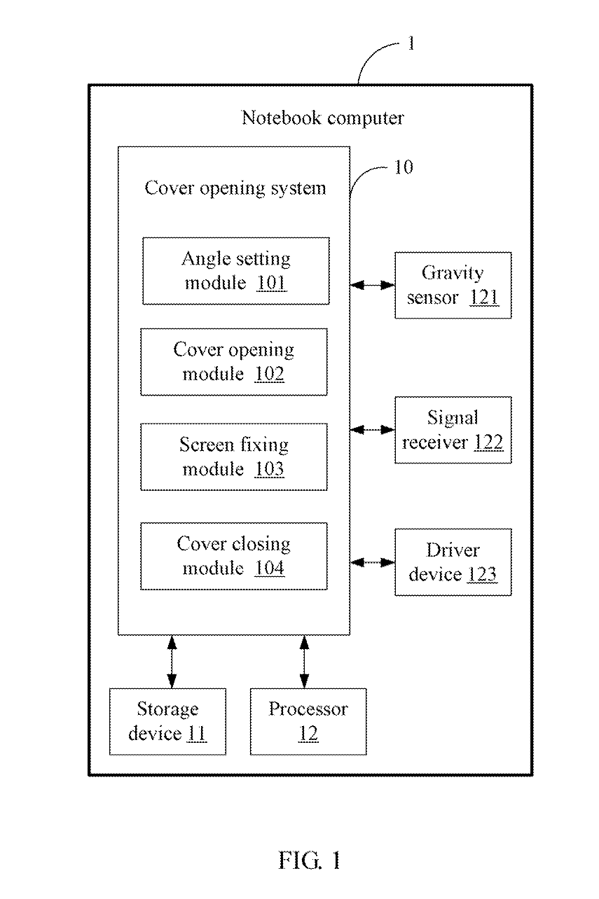

FIG. 1 is a block diagram of one embodiment of a notebook computer 1 including a cover opening system 10. In the embodiment, the notebook computer 1 further includes, but is not limited to, a storage device 11, at least one processor 12, a gravity sensor 121, a signal receiver 122, and a driver device 123. In one embodiment, the storage device 11 is an internal storage system, such as a flash memory, a random access memory (RAM) for temporary storage of information, and/or a read only memory (ROM) for permanent storage of information. The storage device 11 can also be an external storage system, such as an external hard disk, a storage card, or a data storage medium. The at least one processor 12 is a central processing unit (CPU) or microprocessor that performs various functions of the notebook computer 100.

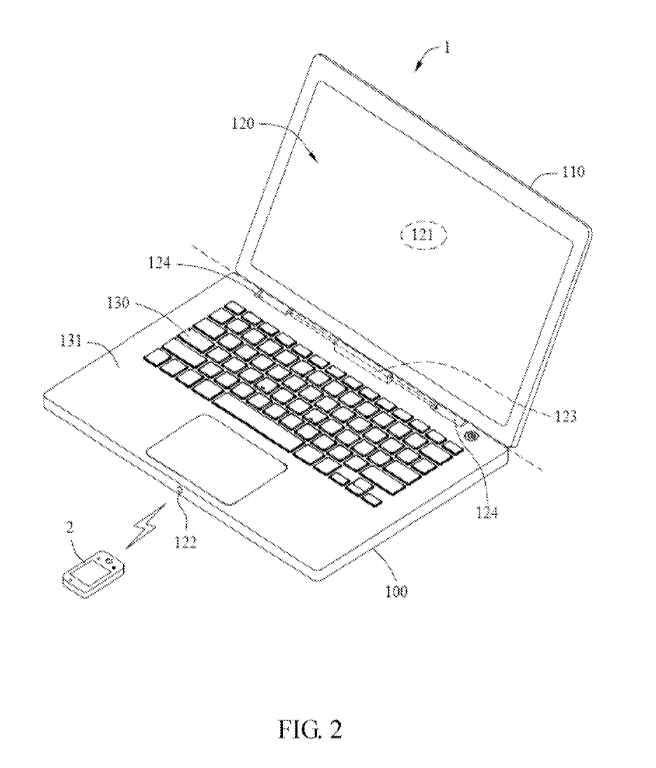

Also referring to FIG. 2 showing one embodiment of an external structure of the notebook computer 1. In the embodiment, the notebook computer 1 further includes, but is not limited to, a base member 100 having a keyboard 130 and a host device 131, and a cover 110 having a display screen 120 and the gravity sensor 121. The cover 110 is connected to the base member 100 through a rotating element 124. The driver device 123 is fixed in a space between the base member 100 and the cover 110. The driver device 123 drives the rotating element 124 to automatically rotate relative to the base member 100, so as to open or close the cover 110.

The display screen 120 is fixed in the cover 110. The cover 110 is rotatable relative to the base member 100 between an open position and a closed position. The gravity sensor 121 is fixed in the cover 110 and is used to sense a tilting angle of the display screen 120 when the cover 110 is in the open position.

The signal receiver 122 is fixed in the base member 100 and used to receive a power-on signal transmitted from a remote controller 2. The power-on signal controls the notebook computer 1 to power on. The driver device 123 drives the rotating element 124 to automatically open the cover 110, so that a tilting angle of the display screen 120 can be adjusted to a proper operation angle. The proper operation angle is predetermined by a user and is stored in a register of the gravity sensor 121.

The cover opening system 10 comprises computerized instructions in the form of one or more computer-readable programs, which are implemented by the notebook computer 1. In the embodiment, the cover opening system 10 includes, but is not limited to, an angle setting module 101, a cover opening module 102, a screen fixing module 103, and a cover closing power-on module 104. The modules 101-104 can comprise computerized instructions in the form of one or more computer-readable programs that are stored in a non-transitory computer-readable medium (such as the storage device 11) and executed by the at least one processor 12. A description of each module is given in the following paragraphs.

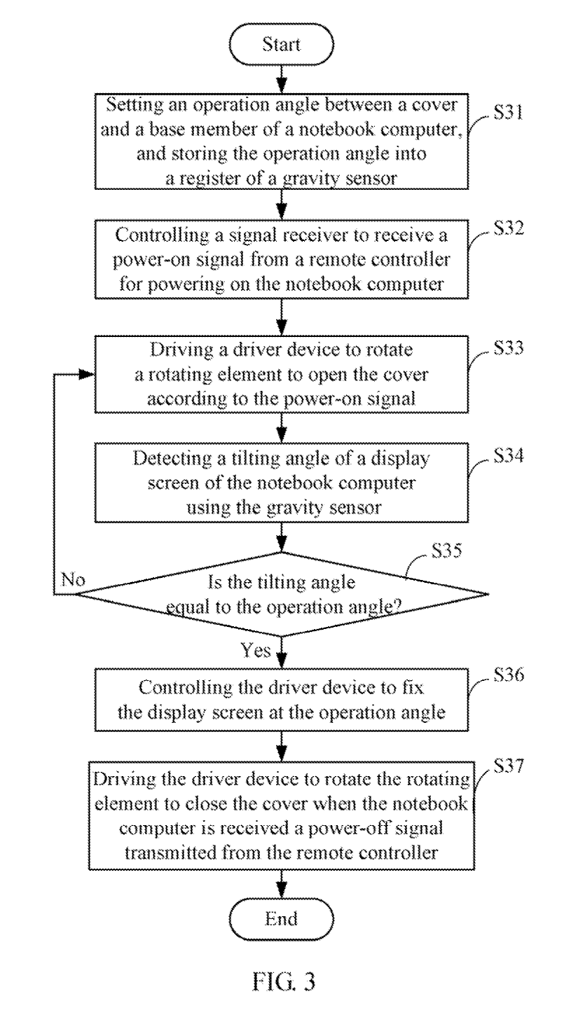

FIG. 3 is a flowchart of one embodiment of a method for automatically opening the cover 110 of the notebook computer 1. In the embodiment, the method is performed by execution of computer-readable software program codes or instructions by the at least one processor 12 of the notebook computer 1. The method can automatically open the cover 110 of the notebook computer 1 and adjust a tilting angle of the display screen 120 to a proper display angle. Depending on the embodiment, additional steps may be added, others removed, and the ordering of the steps may be changed.

In step S31, the angle setting module 101 sets an operation angle between the cover 110 and the base member 100 of the notebook computer 1, and stores the operation angle in a register of the gravity sensor 121. In the embodiment, the operation angle between the cover 110 and the base member 100 is set according to user's requirements. For example, the operation angle is usually set to 120 degrees, so that the user operates the notebook computer 1 conveniently and views the display screen 120 comfortably.

In step S32, the cover opening module 102 controls the signal receiver 122 to receive a power-on signal from the remote controller 2 for powering on the notebook computer. In the embodiment, the power-on signal is a consumer infrared ray (CIR) signal that controls the notebook computer 1 to power on.

In step S33, the cover opening module 102 drives the driver device 123 to rotate the rotating element 124 to open the cover 110 according to the power-on signal. In the embodiment, the rotating element 123 is fixed in a space between the base member 100 and the cover 110.

In step S34, the cover opening module 102 detects a tilting angle of the display screen 120 of the notebook computer 1 using the gravity sensor 121. In the embodiment, the gravity sensor 121 detects the tilting angle of the display screen 120 when the cover 110 is in the open position.

In step S35, the screen fixing module 103 determines whether the tilting angle of the display screen 120 is equal to the preset operation angle. If the tilting angle of the display screen 120 is equal to the preset operation angle, step S36 is implemented. If the tilting angle of the display screen 120 is not equal to the preset operation angle, the process goes back to step S33.

In step S36, the screen fixing module 103 controls the driver device 123 to fix the display screen 120 at the operation angle between the cover 110 and the base member 100, while the user operates the notebook computer 1.

In step S37, the cover closing module 104 drives the driver device 123 to rotate the rotating element 124 to close the cover 110 when the notebook computer 1 receives a power-off signal transmitted from the remote controller 2. In the embodiment, the power-off signal is also a CIR signal that controls the notebook computer 1 to power off.

Although certain disclosed embodiments of the present disclosure have been specifically described, the present disclosure is not to be construed as being limited thereto. Various changes or modifications may be made to the present disclosure without departing from the scope and spirit of the present disclosure.

What is claimed is:

1. A notebook computer, comprising:
a cover having a display screen and a gravity sensor;
a base member, a signal receiver and a driver device;
a storage device storing a computer-readable program including instructions that, which when executed by at least one processor, causes the at least one processor to:
set an operation angle between the cover and the base member, and store the operation angle into a register of the gravity sensor;
control the signal receiver to receive a power-on signal from a remote controller for powering on the notebook computer;
drive the driver device to rotate a rotating element to open the cover according to the power-on signal;
detect a tilting angle of the display screen using the gravity sensor;
determine whether the tilting angle of the display screen is equal to the operation angle between the cover and the base member; and
control the driver device to fix the display screen at the operation angle when the tilting angle of the display screen is equal to the operation angle.

2. The notebook computer according to claim 1, wherein the computer-readable program further causes the at least one processor to drive the driver device to rotate the rotating element to close the cover when the notebook computer receives a power-off signal transmitted from the remote controller.

3. The notebook computer according to claim 1, wherein the gravity sensor is fixed in the cover, and senses the tilting angle of the display screen when the cover is in an open position.

4. The notebook computer according to claim 1, wherein the signal receiver is fixed in a front of the base member, and receives the power-on signal transmitted from the remote controller.

5. The notebook computer according to claim 1, wherein the cover connects to the base member through the rotating element, and the driver device is fixed in a space between the base member and the cover.

6. The notebook computer according to claim 1, wherein the display screen is fixed in the cover which rotates relative to the base member between an open position and a closed position.

7. A method for automatically opening a cover of a notebook computer, the cover comprising a display screen and a gravity sensor, the notebook computer comprising a base member, a signal receiver and a driver device, the method comprising:
setting an operation angle between the cover and the base member, and storing the operation angle into a register of the gravity sensor;
controlling the signal receiver to receive a power-on signal from a remote controller for powering on the notebook computer;
driving the driver device to rotate a rotating element to open the cover according to the power-on signal;
detecting a tilting angle of the display screen using the gravity sensor;
determining whether the tilting angle of the display screen is equal to the operation angle between the cover and the base member; and
controlling the driver device to fix the display screen at the operation angle when the tilting angle of the display screen is equal to the operation angle.

8. The method according to claim 7, further comprising:
driving the driver device to rotate the rotating element to close the cover when the notebook computer receives a power-off signal transmitted from the remote controller.

9. The method according to claim 7, wherein the gravity sensor is fixed in the cover, and senses the tilting angle of the display screen when the cover is in an open position.

10. The method according to claim 7, wherein the signal receiver is fixed in a front of the base member, and receives the power-on signal transmitted from the remote controller.

11. The method according to claim 7, wherein the cover connects to the base member through the rotating element, and the driver device is fixed in a space between the base member and the cover.

12. The method according to claim 7, wherein the display screen is fixed in the cover which rotates relative to the base member between an open position and a closed position.

13. A non-transitory storage medium having stored thereon instructions that, when executed by at least one processor of a notebook computer, causes the processor to perform a method for automatically opening a cover of the notebook computer, the cover comprising a display screen and a gravity sensor, the notebook computer comprising a base member, a signal receiver and a driver device, the method comprising:
setting an operation angle between the cover and the base member, and storing the operation angle into a register of the gravity sensor;
controlling the signal receiver to receive a power-on signal from a remote controller for powering on the notebook computer;
driving the driver device to rotate a rotating element to open the cover according to the power-on signal;
detecting a tilting angle of the display screen using the gravity sensor;
determining whether the tilting angle of the display screen is equal to the operation angle between the cover and the base member; and
controlling the driver device to fix the display screen at the operation angle when the tilting angle of the display screen is equal to the operation angle.

14. The non-transitory storage medium according to claim 13, wherein the method further comprises:
driving the driver device to rotate the rotating element to close the cover when the notebook computer receives a power-off signal transmitted from the remote controller.

15. The non-transitory storage medium according to claim 13, wherein the gravity sensor is fixed in the cover, and senses the tilting angle of the display screen when the cover is in an open position.

16. The non-transitory storage medium according to claim 13, wherein the signal receiver is fixed in a front of the base member, and receives the power-on signal transmitted from the remote controller.

17. The non-transitory storage medium according to claim 13, wherein the cover connects to the base member through the rotating element, and the driver device is fixed in a space between the base member and the cover.

18. The non-transitory storage medium according to claim 13, wherein the display screen is fixed in the cover which is rotates relative to the base member between an open position and a closed position.
